(19) United States
(12) Patent Application Publication
(10) Pub. No.: US 2002/0030647 A1
(43) Pub. Date: Mar. 14, 2002

(54) Uniform active matrix oled displays

(76) Inventors: Michael Hack, Pennington, NJ (US); John H. Bowers, Clarksburg, NJ (US); Richard Hewitt, Ewing, NJ (US)

Correspondence Address: KENYON & KENYON, ONE BROADWAY, NEW YORK, NY, 10004, US

(21) Appl. No.: 09/873,589

(22) Filed: Jun. 4, 2001

Related U.S. Application Data
(63) Continuation-in-part of application No. 09/654,077, filed on Sep. 1, 2000.
Application No. 09/654,077 is a continuation-in-part of application No. 09/588,209, filed on Jun. 6, 2000.

(51) Int. Cl. G09G 3/32; G09G 3/36

(52) U.S. Cl. 345/82; 345/83; 345/92

(57) ABSTRACT

An active matrix display and method of driving the same is provided. The active matrix display comprises an array of pixels, each pixel including an organic light emitting device and at least one thin film transistor. A uniformity correction circuit that is capable of producing a selected pixel brightness is connected to the array of pixels. The uniformity correction circuit is capable of maintaining the brightness of the pixels in a range that does not vary, for example, by more than about 5-10% from their selected brightness values.

This application is a Continuation-In-Part application of U.S. application Ser. No. 09/654,077, filed Sep. 1, 2000, entitled “UNIFORM ACTIVE MATRIX OLED DISPLAYS”, which is a Continuation-In-Part of U.S. application Ser. No. 09/588,209, filed Jun. 6, 2000, which are incorporated by reference herein in their entirety.

### FIELD OF THE INVENTION

The present invention relates to active matrix displays having uniform brightness. More particularly, the present invention relates to uniform active matrix displays that are based on organic light emitting devices (OLEDs).

### BACKGROUND OF THE INVENTION

Flat panel displays typically include an array of picture elements, or pixels, deposited and patterned on a substrate. Such a pixel array is typically a matrix of rows and columns. In an OLED display, each OLED pixel includes an organic light emitting device (sometimes referred to as an organic light emitting diode) that is situated at the intersection of each column and row line. The first OLED displays, like the first LCD (Liquid Crystal Displays), have typically been addressed as a passive matrix (PM) display. This means that to cause a particular pixel to luminesce, electrical signals are applied to the row and column lines of that particular pixel. The more current that is pumped through each pixel, the brighter the pixel appears visually. This means that the grayscale may be provided to the display by varying the current level of the pixel.

In practice, a voltage is applied to a single row line, and then current is simultaneously applied to all the individual columns. This turns on all the pixels on that row line, thus allowing current to flow causing each pixel in that row line to luminesce at the desired brightness. The next row line is then addressed, and once again, all the pixels on that row line are energized to produce the required brightness. The display continuously scans all the row lines sequentially, typically completing at least 60 scans of the overall display each second. In this way, flicker is not seen since the display is addressed fast enough, for typical observation conditions, that the pixels cannot be seen to be continuously turning on and off.

While such a PM-display-addressing scheme is relatively simple, it has the disadvantage that it consumes a relatively large amount of power, particularly for display sizes larger than 2 to 3 inches. The reason for this is that the OLED in each pixel produces luminescence only when current is actually flowing though that pixel since, in the PM-display-addressing scheme, each pixel is only energized when that pixel's row line is being addressed. Since only one row line is addressed at any given time, for a 100-row display, each pixel is on only 1% of the time. To ensure the desired brightness, the current provided to each pixel is typically about 100 times greater than would be necessary if the pixel were allowed to remain on throughout each individual scan cycle. Such large instantaneous peak currents can lead to high power losses in the display. The solution to this problem has been to use active matrix (AM) display addressing.

In an AM display, the array is still divided into a series of row and column lines, with each pixel also being situated at the intersection of a row and column line. However, each pixel now includes, for example, an OLED in series with a thin film transistor (TFT). The TFT functions as a switch that controls the amount of current flowing through the OLED. Whereas in a passive matrix display, the required brightness is determined by directly controlling the amount of current that flows into each pixel OLED, in an active matrix OLED display (AMOLED), information is provided to the transistor of each pixel so as to control how brightly each pixel luminesces. The TFT then stores this information and controls the current flowing through each pixel throughout each scan cycle. Thus, in contrast to PM displays, the pixels in an AMOLED display are allowed to remain on throughout each individual scan cycle. This avoids the need for the very large peak currents that are needed in a PM display. As a result, AMOLEDs typically consume far less power than is needed for a PM display.

However, AMOLEDs are more complicated to manufacture because an array of TFTs (backplane) needs to be built and the AMOLED pixels then need to be placed on top of the TFT backplane. Fortunately for the AMOLED manufacturer, much of the active matrix technology that has been developed for active matrix LCDs, such as used in laptop computers, may also be used for AMOLEDs.

The TFTs that are commonly used as switching elements in active matrix displays tend to suffer from uniformity problems (variations in operating characteristics from TFT to TFT). Additionally, the operating characteristics of such TFTs tend to change over time. Accordingly, conventional devices have employed correction for such variations, but have only done so at the pixel level. These conventional correction methods complicate the pixel by using more components (such as additional TFTs) for each pixel and thus lower the fabrication yield. In addition, these extra components in the pixel reduce the fill factor of the array, that is, the proportion of the total pixel area that is able to emit light.

Conventional active matrix OLED displays typically use PMOS (p-type metal-oxide-semiconductor) TFTs (thin film transistors) as pixel switching elements. This is because it is generally preferable to fabricate OLEDs with the anode on the bottom of the OLED and the cathode on top of the OLED. This means that, since the OLED is typically deposited on the substrate after the TFTs have been mounted on the substrate, whenever PMOS TFTs are used, then the OLED is advantageously connected to the drain side of the TFT. However, if NMOS (n-type metal-oxide-semiconductor) TFTs are used, then the OLED is connected to the source side of the TFT. This configuration is disadvantageous because, to obtain a constant current from a TFT, the load or OLED needs to be on the drain side of the TFT. When the OLED is on the drain side of the TFT, the current flowing through the OLED is relatively independent of the drain to source voltage of the TFT, and is, therefore, independent of the OLED current-voltage (I-V) characteristics. Thus, by using PMOS TFTs, the OLED brightness is much less dependent on variations in the OLED's I-V performance, thus leading to more uniform displays.

A drawback of PMOS TFTs is that in general they have lower mobilities than NMOS TFTs. This means that NMOS TFTs can be made smaller for any given drive current, leading to a higher fill-factor display. The higher mobility of NMOS TFTs also reduces the voltage drop across a TFT for a given current flow, reducing display power consumption.

It would be desirable to be able to manufacture lower cost active matrix OLED arrays with integrated driver circuits. Unfortunately, as compared with external driver circuits based on crystalline silicon, the TFTs that could be useful in the integrated driver circuitry of such lower cost systems, such as amorphous silicon, polysilicon, or organic TFTs, tend to have inferior quality with respect, in particular, to the I-V performance characteristics, from TFT to TFT, and over time for each individual TFT.

There is, thus, a need in the art for an active matrix OLED display that can provide uniform display brightness even if the OLEDs or the driver circuitry have varying characteristics, but without significantly complicating the pixel elements. Such OLED displays could, for example, enable use of either NMOS pixel TFTs or PMOS pixel TFTs, dependent on the desired overall performance characteristics.

There is, in addition, a need to combine these improved lower cost pixel circuits with OLEDs that also have improved performance characteristics. In particular, due to the many benefits and advantages that are provided by OLEDs, especially including overall energy efficiency, there has been much effort in recent years to find materials having still further improved OLED electroluminescent efficiencies. For example, OLEDs originally utilized the electroluminescence produced from electrically excited molecules that emitted light from their singlet states. Such radiative emission from a singlet excited state is referred to as fluorescence. More recent work has demonstrated that OLEDs with higher power efficiencies can be made using organic molecules that emit light from their triplet state, defined as phosphorescence, Baldo et al., “Highly Efficient Phosphorescent Emission from Organic Electroluminescent Devices”, Nature, vol. 395, 151-154, 1998. Since phosphorescent OLEDs have a theoretical internal quantum efficiency of 100% for conversion of the exciton excitation energy into luminescence, as compared with a theoretical internal quantum efficiency of approximately 25% for fluorescent OLEDs, electrophosphorescent OLEDs are inherently capable of having substantially higher internal quantum efficiencies, and, thus, substantially higher external quantum efficiencies, than are possible for OLEDs that only produce fluorescence. As a consequence, since the discovery that phosphorescent materials could be used in an OLED, there has been much interest in developing displays that can effectively utilize the unusually high electroluminescent efficiencies that are possible for phosphorescent OLEDs.

Since electrophosphorescent OLEDs tend to have their highest luminescent efficiency at relatively low current levels, it would be desirable if such OLEDs using the improved, lower cost, pixel circuits, could be operated at such low current levels while still providing the pixel brightness and uniformity levels that are desired for a flat panel display.

### SUMMARY OF THE INVENTION

The present invention is directed to uniform active matrix displays, and methods of producing the same, which use organic light emitting devices in the pixels of the display.

In particular, the present invention is directed to active matrix displays comprising an array of pixels, each pixel including an organic light emitting device and at least one thin film transistor, and a uniformity correction circuit that is connected to the array of pixels and that is capable of producing a selected (or specified pixel) brightness on a pixel-by-pixel basis throughout the lifetime of the display. The active matrix display may include a readout line connecting columns of the pixels and/or a multiplexer that allow sensing of current-voltage characteristics of the pixels.

### BRIEF DESCRIPTION OF THE DRAWINGS

FIG. 1 is a block diagram illustrating an active matrix display of the present invention.

FIG. 2 is a schematic diagram illustrating further details of the active matrix display of FIG. 1.

FIG. 3 is a schematic diagram illustrating a PMOS pixel circuit configuration that may be used with the active matrix display of the invention.

FIG. 4 is a schematic diagram illustrating an NMOS pixel circuit configuration that may be used with the active matrix display of the invention.

FIG. 5 is a schematic cross section of an OLED of the invention.

FIG. 6 is a schematic top view of a pixel including an OLED and the corresponding pixel circuitry components that are located in the pixel adjacent to the OLED.

FIG. 7 is a schematic top view of a pixel including a top emitting OLED for which the corresponding pixel circuitry components are located under the OLED.

FIG. 8 is a schematic diagram illustrating further details of the active matrix display of FIG. 1, and

FIG. 9 is a schematic diagram illustrating further details of the active matrix display of FIG. 1.

### DETAILED DESCRIPTION

The present invention will now be described in detail for specific preferred embodiments of the invention, it being understood that these embodiments are intended only as illustrative examples and the invention is not to be limited thereto.

The present invention is directed to an active matrix OLED display comprising an array of pixels in which a uniformity correction circuit connected to the pixels is used to maintain a specified (or selected) pixel brightness of the display on a pixel-by-pixel basis. The desired display uniformity may be realized independent of the variations of the individual components in the display. The desired display uniformity of the present invention may be provided using, for example, an analog voltage circuit or a pulse-width modulation (PWM) circuit as the means for adjusting the brightness of each pixel. The desired brightness uniformity of pixels in an active matrix display may be characterized as the accuracy for which the brightness of every pixel does not vary by more than about 10% from a selected brightness value. The pixel brightness may be selected for each pixel so as to have a variation in brightness from pixel to pixel that can be maintained within a prescribed range, for example, in a range that also does not vary from pixel to pixel by more than about 10%. Preferably, the pixel brightness may be maintained within a range of not more than about 5%. The materials and methods for preparing such circuitry are described hereinafter, starting first with the circuitry for using an analog voltage.

The present invention is based on the understanding that for OLEDs having known relative dimensions and prepared using substantially the same methods and materials, the current required to produce a selected OLED brightness is reasonably constant from OLED to OLED and such a current remains reasonably constant throughout the lifetime of an array. However, due to substantial variations in the voltage characteristics of the components that are needed in an active matrix circuit, including the individual OLEDs and TFTs in each pixel, as well as the driver circuits, the voltage required to produce a given current in each OLED may vary considerably from pixel-to-pixel and for each pixel during the lifetime of the array. Thus, the voltage required to produce a selected pixel brightness may vary considerably from pixel-to-pixel and for each pixel during the lifetime of the array.

The present invention is directed toward providing the circuitry that calibrates, and then provides, the voltage required to produce a selected brightness for each pixel throughout the lifetime of the array. Calibration of each pixel to select the required voltage to produce a selected pixel brightness may be made at any time during the lifetime of the array with whatever frequency needed to maintain the desired display uniformity. For example, the array may automatically calibrate itself each time it is turned on. Each time a calibration is made, the current-voltage characteristics of every pixel in the array are measured and then stored in a look-up table, for example. This information is then used to set the voltage that is required to produce a selected pixel brightness until the next calibration is made. Thus, the uniformity correction circuitry of the present invention is defined as circuitry that is capable of calibrating, throughout the lifetime of an array, the voltage that is required for each pixel in an array to produce a selected brightness, and then using that information to cause each pixel in an array to luminesce with the selected brightness.

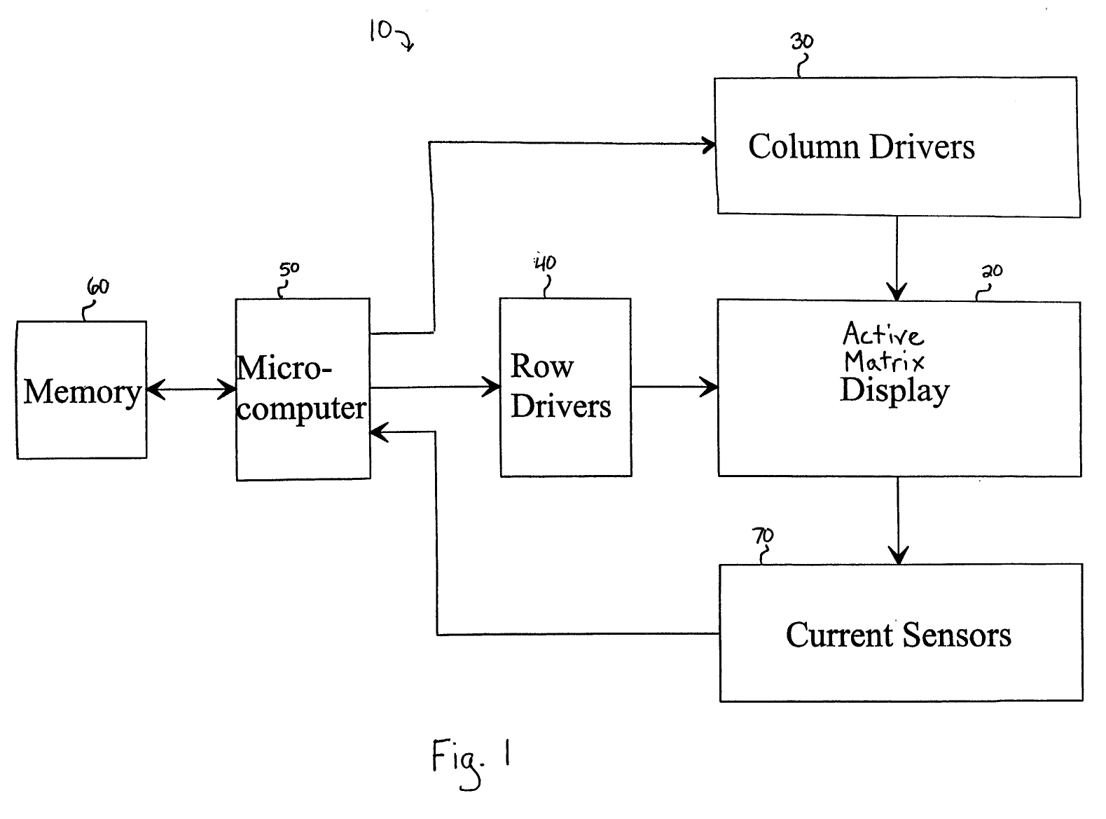

FIG. 1 illustrates an active matrix display 10 of the present invention. The uniformity correction circuit of the display functions in two modes of operation, a normal mode and a calibration mode, as further explained below. The display 10 includes an active matrix display 20 having pixel elements arranged in a matrix. The matrix has columns and rows, and a corresponding one of the pixel elements is arranged at an intersection of each column and row, as further explained below.

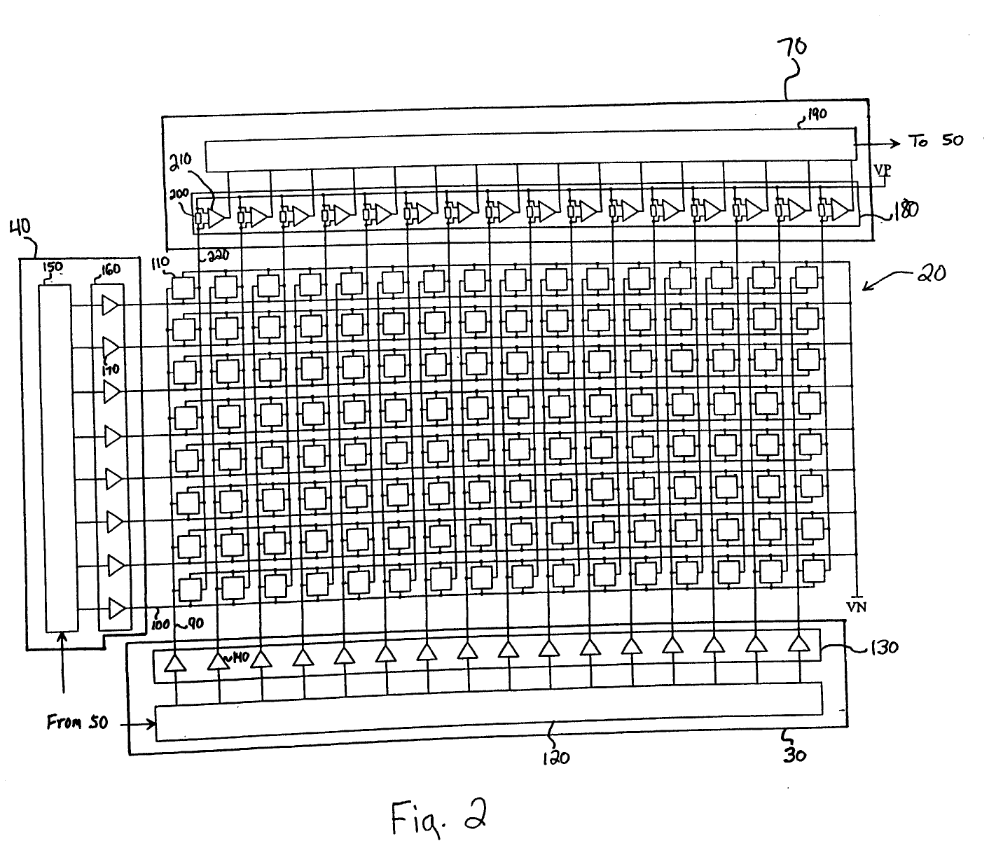

The uniformity correction circuit includes use of a column driver 30 having leads connected to corresponding columns in the matrix and a row driver 40 having leads connected to corresponding rows in the matrix. Microcomputer or controller 50 controls the column driver 30 and row driver 40 to selectively drive pixels in the matrix. The microcomputer 50 stores and retrieves data in memory 60 to provide appropriate signals to the column and row drivers 30 and 40, respectively, to drive the active matrix display 20 with appropriate image data. Data may be communicated from the microcomputer 50 to the column and row drivers 30 and 40, respectively, by any suitable method. The microcomputer 50 should be able to effect the selection of one row at a time and for each row selected, the row data for all of the columns should be presented simultaneously to data drivers 130, which are shown in FIG. 2.

Current sensors 70 are connected to the active matrix display 20 and the microcomputer 50. The function of the current sensors 70 will be explained in detail below. Power supplies are provided to each component of the display as required. The microcomputer 50 utilizes the memory 60 to generate images on the active matrix display 20. However, a wide variety of circuits could be used to control the active matrix display 20.

FIG. 2 illustrates further details of the column and row drivers 30 and 40, respectively, and of the active matrix display 20 of an embodiment of the invention. The active matrix display includes a plurality of column bus lines 90, a plurality of row bus lines 100 crossing the column bus lines, and a plurality of pixels 110. Each pixel 110 is located at the intersection of each column bus line 90 and row bus line 100.

The column drivers 30 are shown at the bottom of FIG. 2 and include signal distribution circuit 120 and data drivers 130. The data drivers 130 may be analog current or analog voltage sources 140 that can apply an appropriate analog current or voltage to corresponding column electrodes 90. This is the method that is typically used for an active matrix OLED. Alternatively, a pulse width modulation (PWM) method may be used. In this case, a current or voltage pulse having a fixed amplitude, but varying width, is used in combination with a pulse width that is adjusted to produce the desired pixel brightness. The PWM method typically requires addressing the pixels at higher frequencies than are used for analog systems so as to provide enough sub-pulses to achieve the desired grayscale. For the analog current or voltage method, the signal distribution circuit 120 is connected to and receives signals from the microcomputer 50. Based on the received signals, the signal distribution circuit causes appropriate current or voltage sources 140 to apply the desired voltage to each of the corresponding column bus lines 90. The signal distribution circuit 120 may be variously implemented as appropriate. For example, the signal distribution circuit 120 may be a series of ports on a microcomputer bus, a demultiplexer, or a shift register, which may shift either analog or digital data.

The row drivers 40 are shown on the left side of FIG. 2 and include row select control circuit 150 and row select drivers 160. The row select drivers are voltage (or current) sources 170 that can apply appropriate voltages to corresponding row bus lines 100. The row select control circuit 150 is connected to and receives signals from the microcomputer 50. The row select control circuit, based on the received signals, causes appropriate voltage sources 170 to apply voltage to the corresponding column bus lines 90. The row select control circuit 150 may be variously implemented as, for example, a shift register or a demultiplexer.

Similarly the signal distribution circuit 120 may be variously implemented as, for example, a series of ports on a microcomputer bus, a demultiplexer, or a shift register which may shift either analog or digital data. Preferably, in order to provide simultaneous presentation of the data to the data drivers 130, the signal distribution circuit 120 incorporates some means of double buffering, i.e., a first means to store the data loaded for each data driver separately from a second data storage means that contains the data used to drive the data driver, and means to transfer data from the first to the second storage means. The latter transfer means is activated simultaneously for all the data drivers whereas data may be stored in the first means (for each data driver) sequentially.

In addition, for either the analog drive method or the PWM method, the pixels may be driven with current drive, instead of voltage as described above. Such current drive is within the scope of the present invention, and can equally well be used to drive the pixels to produce desired greyscale.

The current sensor circuit 70 that is used for calibrating the circuit is shown in the upper part of FIG. 2 and includes current signal collection circuit 190 and current sensing circuit 180. The current sensing circuit includes resistors 200 connected between the inputs of differential amplifiers 210, with one resistor and differential amplifier connected to column current line 220 of each column of pixel elements 110. The current sensor circuit 70 converts the current signal from each column into a corresponding voltage signal.

However, any suitable means of sensing the current may be used. The main requirement is that any voltage drop associated with the current measurement be sufficiently small so as to not affect the operation of the circuit. If current measurement is affected by measuring the voltage drop across resistors, it is either necessary to create very small voltage drops across the resistor in the normal mode of operation, e.g., less than 0.1 volt, or to place switches (not shown) across the current sensing resistors. These switches are closed during normal operation of the display but open during the calibration mode. During the calibration mode, the requirement of a very low voltage drop across the resistors still must be reasonably satisfied in order to adequately assure that the characterization of the pixel circuit is accurate for normal mode operation of display.

The current signal collection circuit 190 is the means by which the signals representing the currents in each column of the display (derived from the current sensing circuits 180) are communicated to the microcomputer 50. Any suitable means of communicating the signals to the microcomputer 50 is within the scope of this invention. As an example, the current signal collection circuit 190 may comprise one or more analog multiplexers and one or more analog to digital converters, the combination connected to the microcomputer data bus by means of buffers and decoders. The main requirement of the current signal collection circuit is that it collects the signals representing the currents in each column of the display fast enough so as to not cause the calibration mode of the display to take an excessive amount of time.

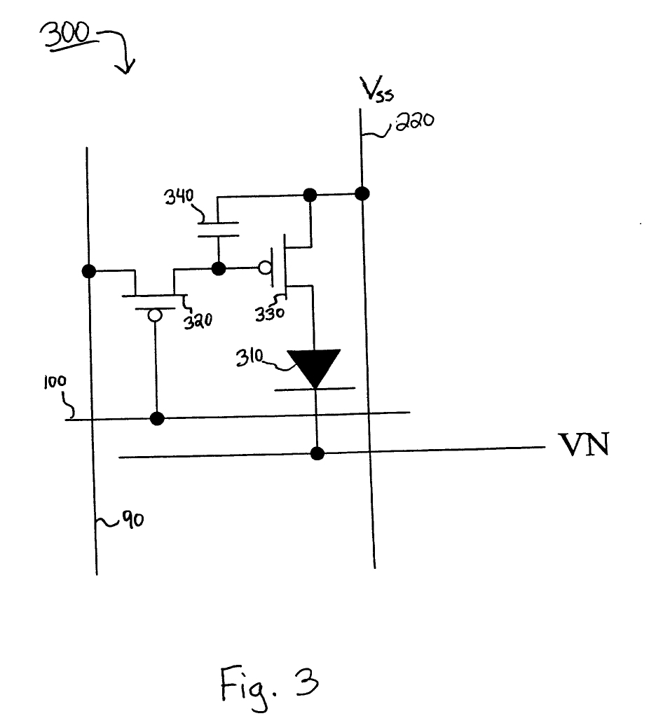

FIG. 3 is a schematic diagram illustrating a PMOS pixel circuit 300 that may be used in the pixels 110 illustrated in FIG. 2. The PMOS pixel circuit 300 includes an OLED 310 connected between VN, a negative voltage line, and the drain of a driver transistor 330, with the drain of the driver transistor being connected to the anode of the OLED 310. The source of the driver transistor 330 is connected to the supply voltage Vₛₛ 220. A pixel select transistor 320 has its gate connected to the row bus line 100, its drain connected to the column bus line 90, and its source connected to the gate of the drive transistor 330. A storage capacitor is connected between the transistors and the supply voltage Vₛₛ 220.

One of the row select drivers 160, of FIG. 2, sends a Row Select signal to the gate of the pixel select transistor 320 thereby enabling or disabling the communication of the data driver signal (from one of the data drivers 130) to the driver transistor that sets the OLED current. Thus, as an example assuming that the source of the pixel drive transistor 330 is at +15 volts, the Row Select signal may be +15 volts when it is desired to disable the select transistor 320 and −10 volts to enable the select transistor 320. The voltage range of the data driver signal may be between +15 volts (for zero current through the OLED) and zero volts (for maximum current through the OLED), for example.

Since the gates of the pixel transistors consume very little current, the row select drivers 160 and the data drivers 130 may have a large output resistance. This can help to reduce power consumption. The only requirement is that the driver circuits be able to provide sufficient current to switch or change the drive voltages fast enough for proper operation of the display. Any suitable circuit topology may be used to implement the driver circuits. For example, the data drivers 130 may comprise operational amplifiers, common emitter/source or common collector/drain amplifiers, analog switches connected to signal storage capacitors, or digital to analog converters.

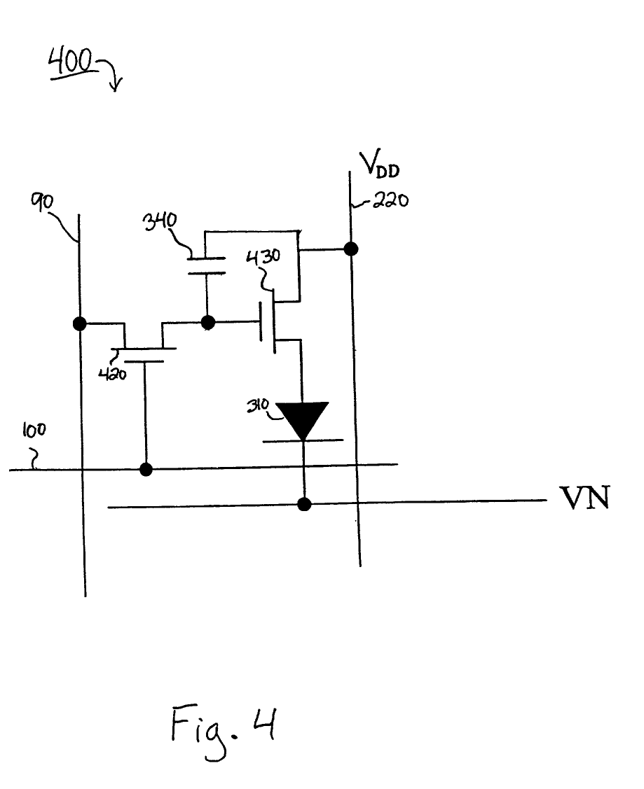

FIG. 4 is a schematic diagram illustrating an NMOS pixel configuration that may be used with the active matrix display as an alternative to the PMOS configuration of FIG. 3. The NMOS circuit is substantially the same as the PMOS circuit except that the drain of the driver NMOS circuit is connected to the supply voltage V_{DD}. In this configuration, since the source of the driver transistor 430 is connected to the anode of the OLED 310, the data driver signal must take the OLED voltage drop into consideration as well. This occurs automatically because of the previously mentioned calibration. Thus, assuming, for example, that VN is 0 volts and the OLED voltage is 7 volts, the data driver signal may range from 7 volts (for zero OLED current) to +22 volts (for maximum OLED current). Similarly, the Row Select Signal may be +7 volts to disable the select transistor 420 and +32 volts to enable the select transistor 420. Any suitable pixel circuit configuration may be used within the pixel of the present invention. However, such a circuit preferably includes only two transistors (a select transistor and a drive transistor), a capacitor for storing the data driver voltage of the drive transistor, and an OLED that is connected to the drive transistor.

As noted above, the uniformity correction circuit of the display system has two modes of operation, a calibration mode and a normal mode. In both modes of operation, the microcomputer 50, which may incorporate or comprise special hardware dedicated for this purpose, provides signals to the column drivers 30 and row drivers 40 causing desired gate signals to be provided and the desired row to be selected. Rows are selected one by one and desired gate signals provided for each row until all rows have been selected, at which point a full cycle has been completed and a complete frame has been displayed. This process repeats itself frame-by-frame.

During calibration, all gate signals for all rows except one, the calibration row, are set at a value such that no current flows through the OLEDs 310 that are not being calibrated. Signals for the calibration row are adjusted over a voltage range such that the current can be measured for the normal operating current range of the OLEDs 310. Measurement of the individual OLED currents is made by the current sensor circuit 70. The measurements of individual OLED current versus the data voltage signal provided to its corresponding drive transistor comprises a characterization of the associated pixel. The characterization of each pixel is stored by the microcomputer 50 in any convenient and suitable format, for example, as a look-up table or as coefficients of a predetermined equation. Each row of the display is calibrated one row at a time until all of the pixels of the display have been characterized.

The characterization may include measuring and storing of individual OLED current versus the data voltage signal provided to its corresponding drive transistor for every pixel at every desired grey level. However, in order to reduce memory requirements, the following two procedures are envisioned. First, OLED current versus the data voltage signal for a few grey levels could be stored, with the other grey levels determined by an appropriate interpolation algorithm. Second, instead of storing OLED current versus the data voltage signal for grey levels for every pixel, the OLED current versus the data voltage signal for grey levels for blocks of pixels having similar characteristics could be stored. For example, during laser processing, it is commonly found that each column of pixels has pixels with very closely matched threshold voltages, but that there may be considerable variation from column to column. Therefore, one approach would be to take measurements for one pixel per column, and to use the stored values for all pixels in the corresponding column.

In normal operation, data driver signals are determined by applying the characterization of the pixels to the pixel data, i.e., the data that represents the desired intensity at which the pixel should be illuminated. As an example, if the characterization is in the form of a look up table, the pixel data selects the appropriate data driver level according to its location within the table. In the example circuits of FIGS. 1 and 2, the storage of the pixel characterization is in the memory 60 attached to the microcomputer. However, the pixel characterization may be stored in any convenient part of the display system. For example, a look up table may be associated with each of the column driver circuits and still be within the scope of the present invention.

Substantially the same circuitry that is used for applying an analog voltage to adjust the pixel brightness may also be used for a PWM method of regulating array uniformity, except that means need to be provided for supplying a voltage pulse and the pulse width modulation. When the PWM method is used, the desired grayscale may be realized by varying the pulse width for a given voltage amplitude. In this case, the current calibration may be carried out using a single voltage pulse at a given amplitude, though a series of pulses with varying amplitudes may typically be used to calibrate the current. If desired, a combination of pulse width modulation and voltage pulse amplitude variation also may be used while remaining within the scope of the present invention.

While it is believed that the present invention may provide benefits and advantages that are uniquely suited to use of amorphous silicon TFTs, the present invention may also be used in combination with other types of thin film transistor technology including, for example, polysilicon, crystalline silicon, CdSe, and organic TFTs. By reducing the demanding performance characteristics that are typically required for TFTs in an AMOLED, it is believed that significant manufacturing and cost advantages may be realized for practical active matrix displays. In particular, since the calibration system of the present invention regulates array uniformity by compensating for variations in each pixel component, the present invention allows much greater latitude to be used in selecting lower quality, but less costly, components in an AMOLED circuit, as well as in how these components are integrated into the overall circuitry. For example, for a top-emitting display that does not require a transparent substrate, the pixel circuitry may be integrated on an opaque substrate surface, with the array of OLEDs mounted on top of the pixel circuitry. One advantage of such an integrated system is that it could be manufactured with lower cost components and higher fill factors.

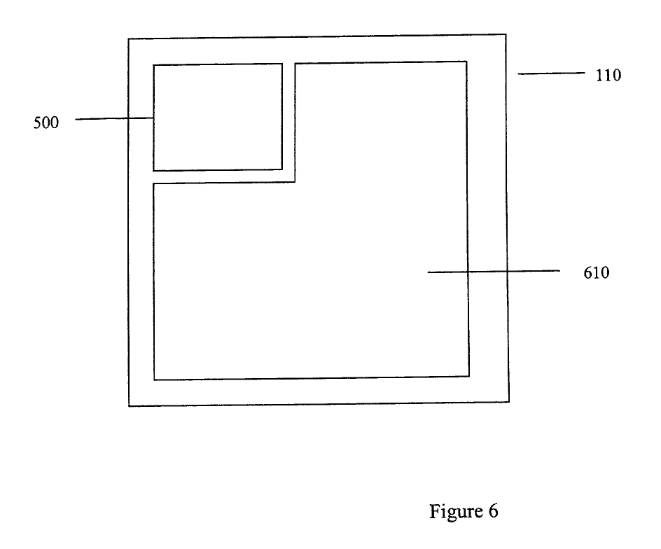

In particular, significantly higher fill factors may be realized by mounting the OLEDs on top of the pixel circuitry components, rather than having the pixel TFTs crowded into the limited space available for each pixel. This is illustrated in FIG. 6, which schematically shows the area allotted to each pixel 110. The fill factor of a pixel is determined by the relative area filled by the OLED 610 as compared to the area filled by the pixel circuitry components 500. The higher the relative area filled by the OLED 610 as compared to the area filled by the pixel circuitry components 500, the higher the fill factor that can be realized. As compared with prior art methods and devices that incorporate additional circuitry components into the very limited space allotted to each pixel, the present invention can achieve a significantly higher fill factor by limiting the number of pixel circuitry components that are crowded into the light emitting region of each pixel.

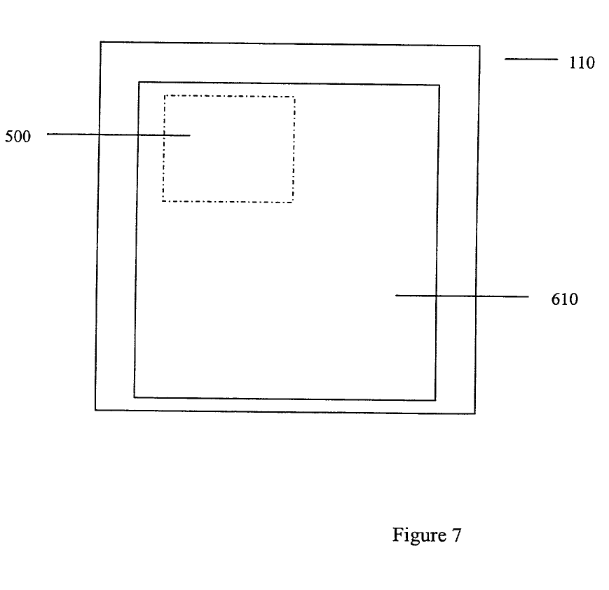

Even further gains in the fill factor are realized for the top-emitting OLEDs that use even less pixel space for the non-emitting circuitry components. This is schematically illustrated in FIG. 7, which shows a top view of a pixel 110 that has the OLED 610 mounted on top of an opaque substrate (not shown). In this case the OLED 610 may be mounted on top of the circuit components 500. When the pixel array is fabricated on an opaque substrate, the individual pixel circuitry components that are required for each pixel in an active matrix array may be incorporated into an integrated structure on the substrate without wasting valuable space that can be more effectively used for light emission.

In addition to realizing higher fill factors by placing the active matrix pixel elements behind a top-emitting OLED, higher fill factors are also realized by use of the uniformity correction circuit, which is also external to the pixel structure. As still another substantial benefit of the present invention, a higher level of integration of the driver cicuitry into the backplane of the active matrix array may also be realized. Use of the uniformity correction circuitry in combination with this more highly integrated structure allows lower cost components and methods to be used for fabricating such active matrix OLED displays.

The preferred embodiments of the present invention comprise using the driver circuitry in combination with an OLED. As representative OLEDs, OLED structures, and circuits for driving such OLEDs, one may use, for example, the methods, materials and s of U.S. Pat. Nos. 5,703,436; 5,707,745; 5,757,139; 5,811,833; 5,834,893; 5,844,363; 5,861,219; 5,874,803; 5,917,280; 5,932,587; 5,981,306; 5,986,401; 5,998,803; 6,013,538; 6,013,982; 6,030,700; 6,030,715; 6,045,930; 6,045,543; 6,048,630; 6,087,196; 6,091,195; and 6,097,147, which are incorporated in their entirety herein by reference.

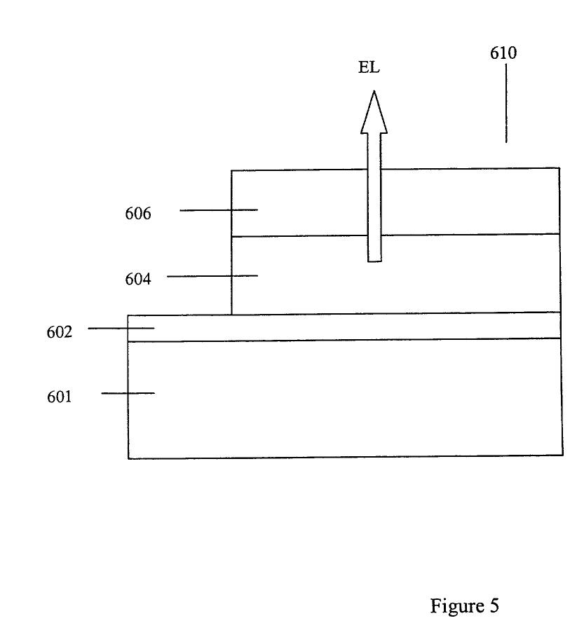

FIG. 5 schematically shows a side view of a multi-layer OLED structure 610 for which the sequence of layers, which are in direct physical contact, includes a substrate 601, which may be opaque or transparent, glass, plastic or metal, and/or rigid or flexible; a first electrode layer 602, which is typically an indium tin oxide (ITO) anode layer; an emissive zone 604, which may consist of a non-heterojunction, single layer or may comprise at least one hole transporting layer and at least one electron transporting layer; and a second electrode layer 606, for example, a metal layer of Mg:Ag and an ITO layer. The electroluminescence (EL) is shown in FIG. 5 as coming out of the top of the OLED, though the EL may also be emitted through the bottom of the OLED. The entire OLED together with the substrate may also be transparent.

The OLEDs may be comprised of emissive materials that produce fluorescent emission when a voltage is applied across the OLED, for example, using the methods and materials such as described in the patents incorporated in their entirety herein. Preferably, the present invention is used in combination with OLEDs that produce phosphorescent emission from the emissive layer of the OLED. In particular, in the preferred embodiments of the present invention, the phosphorescent emission is produced by the radiative emission from triplet excited states of phosphorescent molecules in the emissive layer. The phosphorescent molecules are excited to their triplet excited states by the energy provided by the recombination of the holes and electrons that are produced in the emissive layer when a voltage is applied across an OLED. Such phosphorescent materials are disclosed, for example, in Baldo et al., “Highly Efficient Phosphorescent Emission from Organic Electroluminescent s”, Nature, vol. 395, 151-154, 1998; Baldo et al., “Improved Energy Transfer in Electrophosphorescent s”, Appl. Phys. Let., vol. 74, 442-444, 1999; and Baldo et al., “Very High-Efficiency Green Organic Light emitting devices Based on Electrophosphorescence”, Appl. Phys. Let., vol 75, 4-6, 1999.

A representative phosphorescent material is factris(2-phenylpyridine)iridium [Ir(ppy)₃]. Such a phosphorescent material is reported to be capable of producing peak quantum and power efficiencies of up to 19.0% (66 cd/A) and 31 lm/W, respectively, or a luminance of 100 cd/m², with quantum and power efficiencies of 10.0% (35 cd/A) and 15 lm/W, respectively. Using such phosphorescent materials in an OLED in combination with the drivers of the present invention makes it possible to operate the individual pixels with less than only one microampere per pixel, while still achieving a desired luminance level of at least about 10 cd/m², and, preferably, at least about 100 cd/m². Such low currents provide an additional practical benefit since they permit use of the lower-mobility TFT technologies, such as amorphous silicon or organic TFTs, which are preferably operated at the very low currents that are made possible by the use of phosphorescent OLEDs. Each pixel in the array of the present invention is preferably comprised of an OLED having an emission layer including a phosphorescent material that produces phosphorescent emission from a triplet molecular excited state when a voltage is applied across the OLED.

The OLEDS may be top-emitting OLEDS comprised of transparent electrodes using the materials such as described in U.S. Pat. Nos. 5,703,436 and 5,707,745. As a representative embodiment of such transparent electrodes, the top-emitting OLED, which is schematically illustrated in FIG. 5, may include a transparent cathode layer 606 as the second electrode. This cathode layer may comprise a thin metal layer having a thickness of less than 100 angstroms, or even less than 50 angstroms, for example, a metal layer comprising Mg, Ag, or a combination thereof. Such layers may also include an indium-tin-oxide (ITO) layer that is deposited directly on top of the thin metal layer. Alternatively, the transparent electrode may be a transparent non-metallic cathode such as described in Parthasarathy et al., A Metal-Free Cathode for Organic Semiconductor s, Appl. Phys. Lett., Vol. 72, 2138-2140 (1998). For example, as an alternative to the second electrode layer 606 that is formed from a layer of Mg:Ag and a layer of ITO, the second electrode layer may comprise a semi-conductive, non-metallic, organic layer, such as copper phthalocyanine (CuPc), that is in direct low-resistance contact with an ITO layer. As still another alternative, the transparent cathode 606 may comprise a metal-doped electron-injection layer, for example, a Li-doped layer electron-injection layer such as described in Parthasarathy et al., High Efficiency Transparent Organic Light-Emitting s, Appl. Phys. Lett. Vol. 76, 2128-2130 (2000). The entire array of pixels may be comprised of top-emitting OLEDs that have a transparent cathode on top of the OLED, wherein the substrate is designated as being on the bottom of the OLED.

The arrays of the present invention may include pixels that are each comprised of the same type of color-producing OLED, thus pixels that all produce the same emission color. This is typically referred to as a monochrome display. Alternatively, the array may be comprised of more than one type of color-producing pixel, with each type of pixel including a single color-producing OLED. This is typically referred to as a multi-color display. For example, in this case, one region of the display may produce a single color, another region produces a second color, and another region produces a third color. Finally, the array may be comprised of pixels that each include more than one color-producing OLED, for example, OLEDs that produce each of the three primary colors, red (R), green (G) and blue (B). This is typically referred to as a full-color display.

One of the preferred embodiments includes, for example, use of a flexible organic light emitting device on a flexible substrate, such as disclosed in U.S. Pat. No. 5,844,363. The charge transporting layers are preferably comprised of nonpolymeric small molecule materials, and the flexible substrate may be comprised of, for example, polyimide (PI) such as KAPTON™ from BF Goodrich, polyethersulphone (PES), polyetherimide (PEI), polyarylate (PAC), polyester, polyestercarbonate (PC), polyethylenenapthalate (PEN), polyethyleneterephthalate (PET), or still other flexible materials, including flexible glasses or a metal foil such as aluminum foil. The array of pixels may be mounted on a flexible substrate comprised of such materials.

Another benefit of the present invention is that when opaque flexible substrates are used for top-emitting devices, the opaque flexible substrates may be selected from higher temperature plastics than is generally found for transparent plastics. The higher temperatures make it easier to fabricate thin film transistors on the substrate.

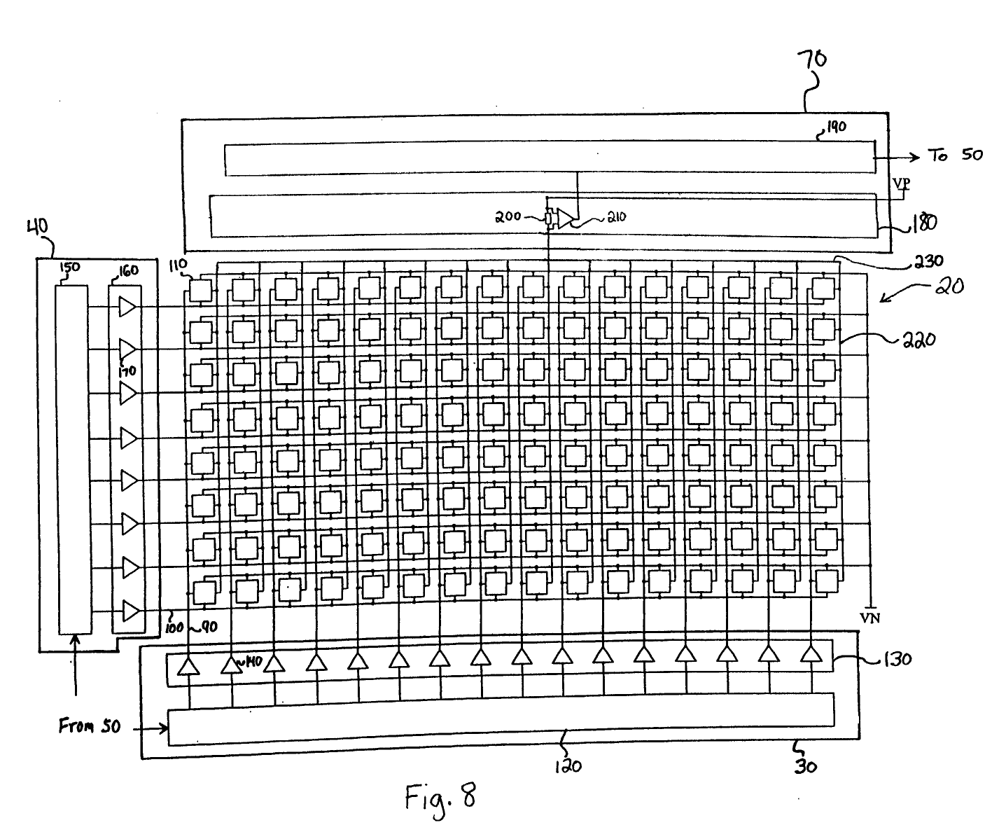

FIG. 8 illustrates further details of the column and row drivers 30 and 40, respectively, and of the active matrix display 20 of an embodiment of the invention. FIG. 8 shares common elements with the embodiment of FIG. 2, with common elements sharing common reference numerals. Additionally, the FIG. 8 embodiment includes a common readout line 230 connected to each of the column current lines 220. The readout line 230 may be disposed within the active matrix display 20 as shown in FIG. 8, between the active matrix display 20 and the current sensor circuit 70, or within the current sensor circuit 70.

Use of the readout line 230 substantially simplifies the embodiment of FIG. 2 by requiring only a single line between the active matrix display 20 and the current sensor circuit 70. Also, by including the readout line 230, only a single current sensor is needed to sense the currents of the pixels to calibrate the circuit as described above in conjunction with FIG. 2. Thus, in this embodiment, only a single resistor 200 and differential amplifier 210 is needed to sense the currents on each of column current lines 220.

Prior to calibration, data is loaded into every pixel to ensure that no current is flowing through any of the OLED devices. During the calibration mode, a particular row is selected, and all data signals for all columns except one are set at a value such that no current flows through the OLEDs 310 that are not being calibrated. Signals for the calibration pixel are adjusted over a voltage range such that the current can be measured for the normal operating current range of the OLEDs 310. Measurement of the individual OLED currents is made by the current sensor circuit 70. The measurements of individual OLED current versus the data voltage signal provided to its corresponding drive transistor comprises a characterization of the associated pixel. The characterization of each pixel is stored by the microcomputer 50 in any convenient and suitable format, for example, as a look-up table or as coefficients of a predetermined equation. Each row of a column of the display is calibrated one row at a time until all of the pixels of the column have been characterized. The remaining columns are then selected one by one for calibration of pixels on a pixel-by-pixel basis.

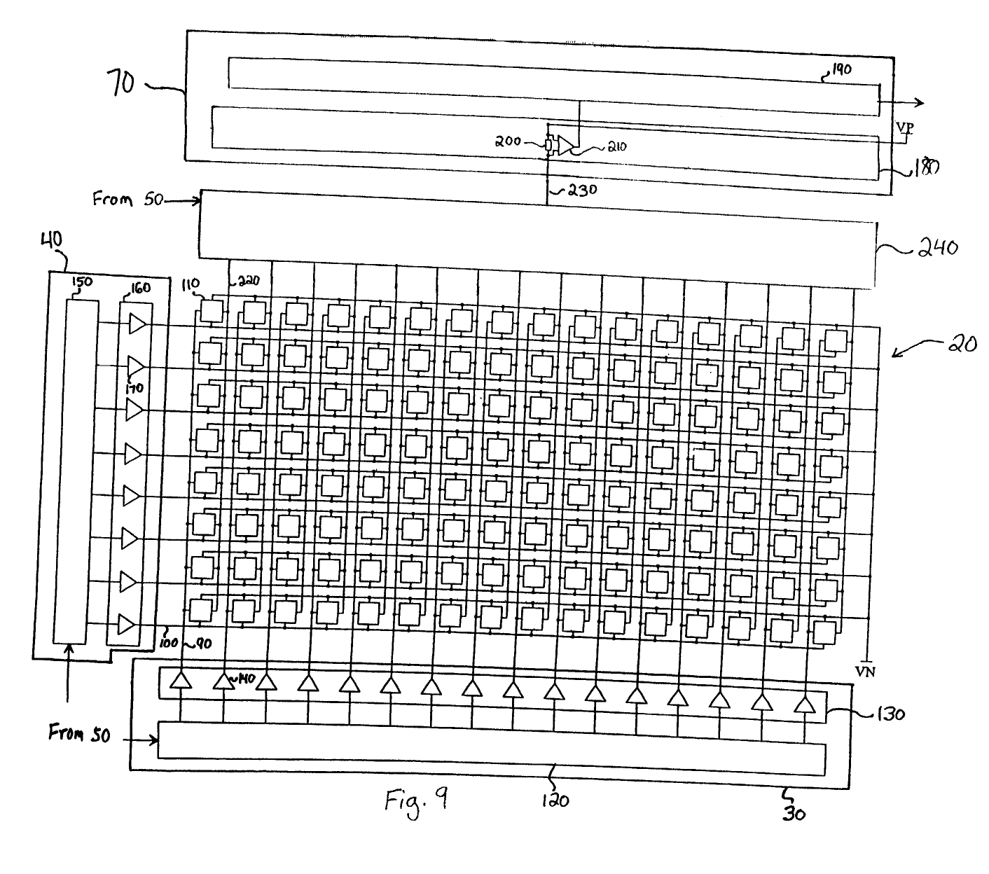

FIG. 9 illustrates further details of the column and row drivers 30 and 40, respectively, and of the active matrix display 20 of an embodiment of the invention. FIG. 9 shares common elements with the embodiment of FIG. 2, with common elements sharing common reference numerals. Additionally, the FIG. 9 embodiment includes a multiplexer 240. The multiplexer 240 may be alternatively be disposed within the active matrix display 20, between the active matrix display 20 and the current sensor circuit 70, or within the current sensor circuit 70.

The multiplexer 240 has a plurality of inputs, that are connected to the column current lines 220, and an output connected to the current sensor circuit 70. The multiplexer 240 may be controlled by the microcomputer 50 by control connections not shown in the figures. For large displays having a large number of columns (e.g. 1024 columns), a plurality of multiplexers may replace the single multiplexer 240, with each of the plurality of multiplexers connected to a portion of the total number of column lines. Additionally, the multiplexer 240 may have more than one output. Generally, the number of outputs of the multiplexer (or multiplexers) will correspond to the number of currents sensors used within the current sensor circuit 70, with one multiplexer output connected to each of the current sensors (resistor 200 and differential amplifier 210). For example, if a single multiplexer 240 is used having a number of inputs equal to the number of column current lines, and having two outputs, then two current sensors would be used. If four multiplexers 240 are used each having one output, then four current sensors would be used. Use of one or more multiplexers can reduce the number of current sensors needed as compared to the embodiment of FIG. 2.

Prior to calibration, data is loaded into every pixel to ensure that no current is flowing through any of the OLED devices. During the calibration mode, each row is addressed one row at a time. The multiplexer 240 (or multiplexers) are used to allow current signals from one column (or a number of columns equal to the number of multiplexer outputs) at a time to be sensed by the current sensor circuit 70. The microcomputer 50 will then control the multiplexers to connect the other columns column by column until all columns for a particular row are connected for sensing of currents. Signals for the calibration pixels are adjusted over a voltage range such that the current can be measured for the normal operating current range of the OLEDs 310. Measurement of the individual OLED currents is made by the current sensor circuit 70. The measurements of individual OLED current versus the data voltage signal provided to its corresponding drive transistor comprises a characterization of the associated pixel. The characterization of each pixel is stored by the microcomputer 50 in any convenient and suitable format, for example, in memory 60 or as a look-up table or as coefficients of a predetermined equation. Each row of the display is calibrated one column or more columns equal to the number of multiplexer outputs at a time, until all of the pixels of the row have been characterized. The remaining rows are then selected one by one for calibration of pixels in a similar basis.

This aspect of the invention allows for a tradeoff in speed versus complexity, where an increased number of current sensors will increase both the speed of the calibration and the complexity of the display. Additionally, the multiplexers may have one output or a plurality of outputs, with each output connected to an individual current sensor.

The display may be provided in any size, including displays as small as a few millimeters to as large as the size of a wall of a building, for almost any application. The images created on the display could be text or illustrations in full color, in any resolution depending on the size of the individual LED's. Displays of the present invention are therefore appropriate for an extremely wide variety of applications including billboards and signs, computer monitors, displays for portable appliances such as cellphones, laptops, personal digital assistants and vehicle displays, telecommunications s such as telephones, televisions, large area wall screens, theater screens, stadium screens, and signs.

Several embodiments of the present invention are specifically illustrated and described herein. However, it will be appreciated that modifications and variations of the present invention are covered by the above teachings and are within the purview of the appended claims without departing from the spirit and intended scope of the invention.

We claim:

1. An active matrix display, comprising:
an array of pixels arranged in a plurality of columns and rows, each pixel including an organic light emitting device and a thin film transistor;
at least one readout line, each readout line connected to a plurality of the columns; and
a uniformity correction circuit connected to the at least one readout line, the uniformity correction circuit producing a selected pixel brightness on a pixel-by-pixel basis based on signals from the at least one readout line.

2. The active matrix display of claim 1, wherein the uniformity correction circuit includes a current sensor circuit connected to the at least one readout line.

3. The active matrix display of claim 2, wherein the at least one readout line comprises a plurality of readout lines.

4. The active matrix of claim 3, wherein the current sensor circuit is connected to each of the plurality of readout lines.

5. The active matrix of claim 4, wherein the current sensor circuit comprises a plurality of resistors and differential amplifiers, one of the resistors and one of the differential amplifiers connected to each readout line.

6. The active matrix display of claim 5, wherein the uniformity correction circuit includes a microcomputer connected to the current sensor circuit, and a memory connected to the microcomputer.

7. The active matrix display of claim 6, wherein the microcomputer receives signals representative of the sensed currents from the current sensor circuit, and stores the signals in the memory.

8. The active matrix display of claim 6, wherein the microcomputer receives signals representative of the sensed currents from the current sensor circuit during a calibration mode, and stores the signals in the memory.

9. The active matrix display of claim 8, wherein the microcomputer causes a plurality of differing voltage signals to be applied to each organic light emitting device, receives a plurality of signals representative of sensed currents from the current sensor circuit, and stores the signals in the memory.

10. The active matrix display of claim 9, wherein the microcomputer generates a characterization of each pixel element based on the stored signals.

11. The active matrix display of claim 10, further comprising a column driver located between the microcomputer and the columns of pixels, wherein the microcomputer causes the column driver to apply voltage levels to the organic light emitting devices based on the corresponding characterizations.

12. The active matrix display of claim 1, wherein the display is incorporated in one of a computer, a printer, a sign, a telecommunications device, a television, a vehicle, a screen, or a telephone.

13. The active matrix display of claim 1, further comprising a multiplexer having an output and a plurality of inputs, wherein the at least one readout line is connected to the output of the multiplexer, and each input of the multiplexer is connected to one of the columns.

14. The active matrix display of claim 1, wherein the uniformity correction circuit is capable of maintaining the brightness of the pixels to within about 5% of a selected value.

15. The active matrix display of claim 1, wherein the array of pixels is mounted on a flexible substrate.

16. The active matrix display of claim 15, wherein the flexible substrate is transparent.

17. The active matrix display of claim 15, wherein the flexible substrate is opaque.

18. The active matrix display of claim 1, wherein each of the pixels in the array comprises a top-emitting organic light emitting device.

19. The active matrix display of claim 18, wherein the organic light emitting devices have an emission layer including a phosphorescent material.

20. An active matrix display, comprising:
an array of pixels arranged in a plurality of columns, each pixel including an organic light emitting device and a thin film transistor;
a multiplexer having a plurality of inputs and at least one output, each input connected to one of the columns; and
a uniformity correction circuit connected to the at least one output of the multiplexer, the uniformity correction circuit producing a selected pixel brightness on a pixel-by-pixel basis based on signals from the multiplexer.

21. The active matrix display of claim 20, wherein the uniformity correction circuit includes a current sensor circuit connected to the output of the multiplexer.

22. The active matrix display of claim 21, wherein the current sensor circuit comprises a resistor and a differential amplifier connected to the output of the multiplexer.

23. The active matrix display of claim 21, wherein the multiplexer has a plurality of outputs, and the current sensor circuit comprises a plurality of resistors and a plurality of differential amplifiers, one of the resistors and one of the differential amplifiers connected to each of the outputs of the multiplexer.

24. The active matrix display of claim 21, wherein the uniformity correction circuit includes a microcomputer connected to the current sensor circuit, and a memory connected to the microcomputer.

25. The active matrix display of claim 24, wherein the microcomputer receives signals representative of sensed currents from the current sensor circuit, and stores the signals in the memory.

26. The active matrix display of claim 24, wherein the microcomputer receives signals representative of the sensed currents from the current sensor circuit during a calibration mode, and stores the signals in the memory.

27. The active matrix display of claim 20, wherein the microcomputer causes a plurality of differing voltage signals to be applied to each organic light emitting device, receives a plurality of signals representative of sensed currents from the current sensor circuit, and stores the signals in the memory.

28. The active matrix display of claim 27, wherein the microcomputer generates a characterization of each pixel element based on the stored signals.

29. The active matrix display of claim 28, further comprising a column driver located between the microcomputer and the columns of pixels, wherein the microcomputer causes the column driver to apply voltage levels to the organic light emitting devices based on the corresponding characterizations.

30. The active matrix display of claim 20, wherein the display is incorporated in one of a computer, a printer, a sign, a telecommunications device, a television, a vehicle, a screen, or a telephone.

31. The active matrix display of claim 20, further comprising a readout line connected between the at least one output of the multiplexer and the uniformity correction circuit.

32. The active matrix display of claim 20, wherein the array of pixels is mounted on a flexible substrate.

33. The active matrix display of claim 32, wherein the flexible substrate is transparent.

34. The active matrix display of claim 32, wherein the flexible substrate is opaque.

35. The active matrix display of claim 20, wherein each of the pixels in the array comprises a top-emitting organic light emitting device.

36. The active matrix display of claim 35, wherein the organic light emitting devices have an emission layer including a phosphorescent material.

37. A method of maintaining a selected pixel brightness on a pixel-by-pixel basis on an active matrix display, the active matrix display having the pixels arranged in a plurality of columns and rows, comprising:
measuring current-voltage characteristics of pixels in the active matrix display through a readout line, the readout line connected to a plurality of the columns;
storing the current-voltage characteristics in a look-up table; and
using the current-voltage characteristics to select the voltage required to produce a selected pixel brightness for each pixel in the active matrix display; and
applying said voltage for each pixel in the active matrix display to the corresponding pixel in the display so as to produce a desired pixel brightness.

38. The method of claim 37, further comprising selecting each column of pixels in the array for measuring the current-voltage characteristics with a multiplexer having inputs connected to the columns of pixels and an output connected to the readout line.
